(19) United States
(12) Patent Application Publication
(10) Pub. No.: US 2015/0170116 A1
(43) Pub. Date: Jun. 18, 2015

(54) ONLINE SELF CONTAINED PORTABLE INTERACTIVE TRANSACTIONAL SYSTEM

(71) Applicant: TRANSCAST, INC., Houston, TX (US)

(72) Inventor: Guillermo Antonio Amtmann, Houston, TX (US)

(73) Assignee: TRANSCAST, INC., Houston, TX (US)

(21) Appl. No.: 14/090,836

(22) Filed: Nov. 26, 2013

(51) Int. Cl. G06Q 20/10; G06Q 20/34

(52) U.S. Cl. CPC G06Q 20/10; G06Q 20/34

(57) ABSTRACT

A system for providing connectivity from a transport vehicle to a transport vehicle company, a financial institution, a third party provider, and an administrative processor via a network using administrative data storage, a dynamic library of viewing content, and a dynamic driver profile. A portable media device installed in the transport vehicle for viewing content using an interactive dynamic customized dashboard, wherein the portable media device has a payment reader, a portable media device processor with portable mediate device data storage containing computer instructions to enable the purchase of the travel fare, entertainment, goods, and services, along with the ability to pay bills, donate to a charity, perform banking operations, book a reservation, or purchase information.

### FIELD

The present embodiments generally relate to a portable system for presenting purchase options to a passenger in a common carrier vehicle and providing connectivity from a transport vehicle to a transport vehicle company, a financial institution, a third party provider and an administrative processor via a network.

### BACKGROUND

A need exists for a compact, self-contained system capable of interacting with the passenger of a vehicle enabling the passenger to make purchase options including but not limited to downloading internet content, and purchasing items.

A need exists for a system to make use of otherwise unproductive time spent riding in a transport vehicle.

A further need exists for a solution that can provide benefits to the community, cab companies and independent drivers, by using technology that will have a positive impact on the environment and increment productivity by empowering the public transportation industry to deliver tools and methods to perform daily tasks while confined in a transportation vehicle.

A further need exists for a compact, all in one, integrated solution for offering products and services to passengers, while accepting multiple forms of payment.

The present embodiments meet these needs.

### BRIEF DESCRIPTION OF THE DRAWINGS

The detailed description will be better understood in conjunction with the accompanying drawings as follows:

FIG. 1 is a communication diagram of the system including the network and other components used by the system.

FIG. 2 is a diagram of the components of an embodiment of a portable media device.

FIG. 3 depicts the portable media device installed in a transport vehicle.

FIG. 4 shows the portable media device data storage.

FIG. 5 shows the dynamic driver profile.

FIG. 6 shows an embodiment of the onboard trip-tracking computer.

FIG. 7 shows an embodiment of the administrative data storage.

FIG. 8 shows an embodiment of a portable media device in a holding case mounted to a headrest of a transport vehicle.

The present embodiments are detailed below with reference to the listed Figures.

### DETAILED DESCRIPTION OF THE EMBODIMENTS

Before explaining the present system in detail, it is to be understood that the system is not limited to the particular embodiments and that it can be practiced or carried out in various ways.

The present embodiments generally relate to a portable system for presenting purchase options to a passenger in a common carrier vehicle and providing connectivity from a transport vehicle to a transport vehicle company, a financial institution, a third party provider and an administrative processor via a network.

A benefit of the system is that it conserves fossil fuels by enabling a passenger in a transport vehicle to shop while riding to a destination, saving an extra shopping trip and saves trees by enabling users to receive their receipts through an electronic medium.

A benefit of the system is that being connected to the Internet and receiving news about a traffic accident that is on the roadway, the passenger can tell the driver how to avoid an emergency situation.

A benefit of the system is that it allows payment by credit or debit card and near field communication payment methods, such as GOOGLE™ wallet, or RFID (Radio-Frequency Identification) chips embedded in plastic embodiments and allows the driver to carry less cash, thereby reducing the risk of loss and theft.

A benefit of the system is that it allows instant communication to services such as fire, police, and ambulance in the event of an emergency.

A benefit of the system is that it allows video and audio recording in the event of an emergency, thereby providing valuable information to insurance, police, fire, or medical personnel.

A passenger will see the interactive system upon entering a vehicle. The system is user friendly, and allows the passenger to make use of otherwise unproductive time.

The passenger can intuitively select options to view products and services to purchase that are shown on a display. The passenger is allowed to select multiple items to purchase from multiple screens if desired. In many cases, a passenger can complete a purchase in as little as three steps.

The passenger can combine multiple items selected for purchase into a single payment. The passenger can pay using multiple forms of payment.

The system can allow the passenger to combine a fare for travel with one or more purchases.

The system can accept payment using a magnetic card reader, a near field communication reader, a smart chip reader, or manual entry.

The system can process the payment while the vehicle is in transit.

Upon payment, the passenger can choose to receive proof of payment via printed receipt, email, text, or similar methods.

The system can also provide a hotspot for internet access, power outlets, information, access to the internet on the interactive system, and entertainment for the passenger.

A common carrier can use the system to track vehicles, generate additional revenue, transmit data, and gather data.

The system can be implemented by placing a portable media device in a transport vehicle. A transport vehicle company can provide this to its drivers.

The portable media device can connect to an administrative data storage to track driver information, shift activity information, and revenue information.

The system allows for the distribution of revenue to all relevant parties.

The system can include a portable media device with a self-contained processor and data storage. The portable media device can be installed within a vehicle for use by a passenger.

The system can also contain an administrative processor and administrative data storage wirelessly connected to the portable media device.

The administrative data storage can have a set of computer instructions that monitors the status of the portable device.

The administrative data storage and processor can update the computer instructions resident in the portable media device.

The term “third party provider” as used herein can refer to suppliers of movies and entertainment via the internet, online merchants and suppliers of products, such as AMAZON™, online service providers, such as a phone carrier, a long distance company, and online charities.

The term “financial institution” as used herein can refer to a credit card or debit card, other payment processing companies, a bank, a credit union, a wire transfer or money transfer service, or a currency exchange.

The term “transport vehicle company” as used herein can refer to a cab operator, a trucking company, limousine operators, shuttle bus operators, and other operators of common carrier vehicles.

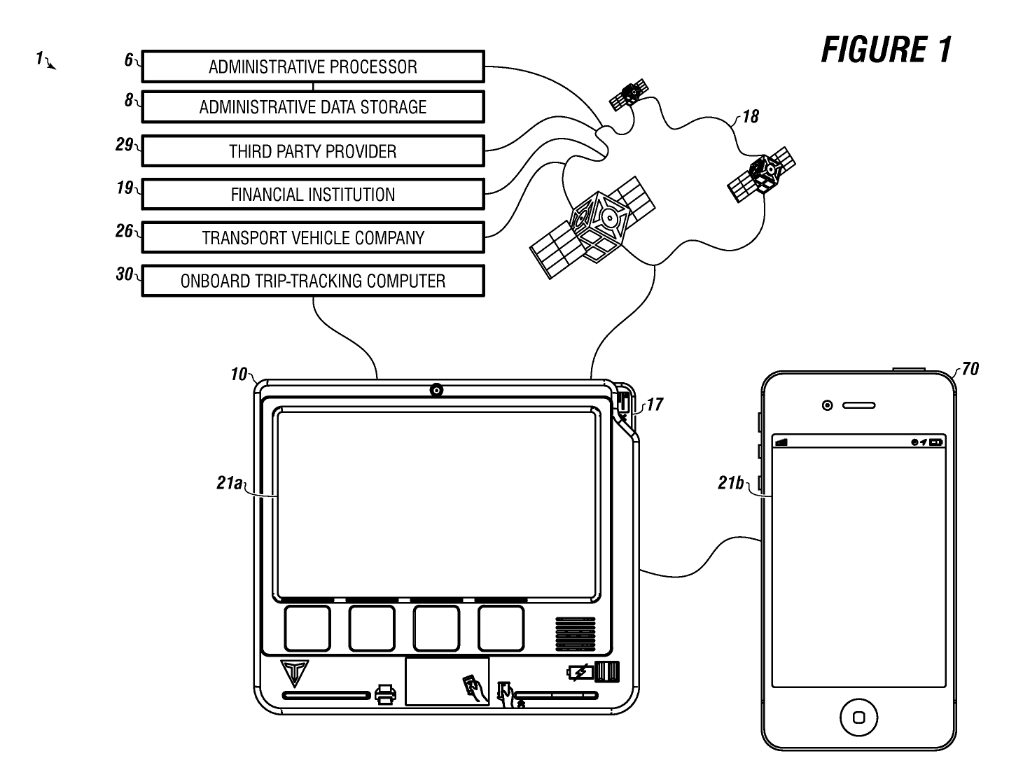

Turning now to the Figures, FIG. 1 is a communication diagram of the system including the network and other components used by the system.

The system 1 can use a network 18 to be in communication with a transport vehicle company 26, a financial institution 19, and a third party provider 29.

An administrative processor 6 can be in communication with the network 18 and an administrative data storage 8.

An onboard trip-tracking computer 30 can also be in communication with the network 18.

A portable media device 10 can be in communication with the network 18. The portable media device 10 can have a portable media device processor.

A client device 70 can interact with the system 1 and the portable mediate device 10 and can receive content from the portable media device 10. The client device 70 can be a smart phone, a cell phone, a tablet, or a similar handheld device.

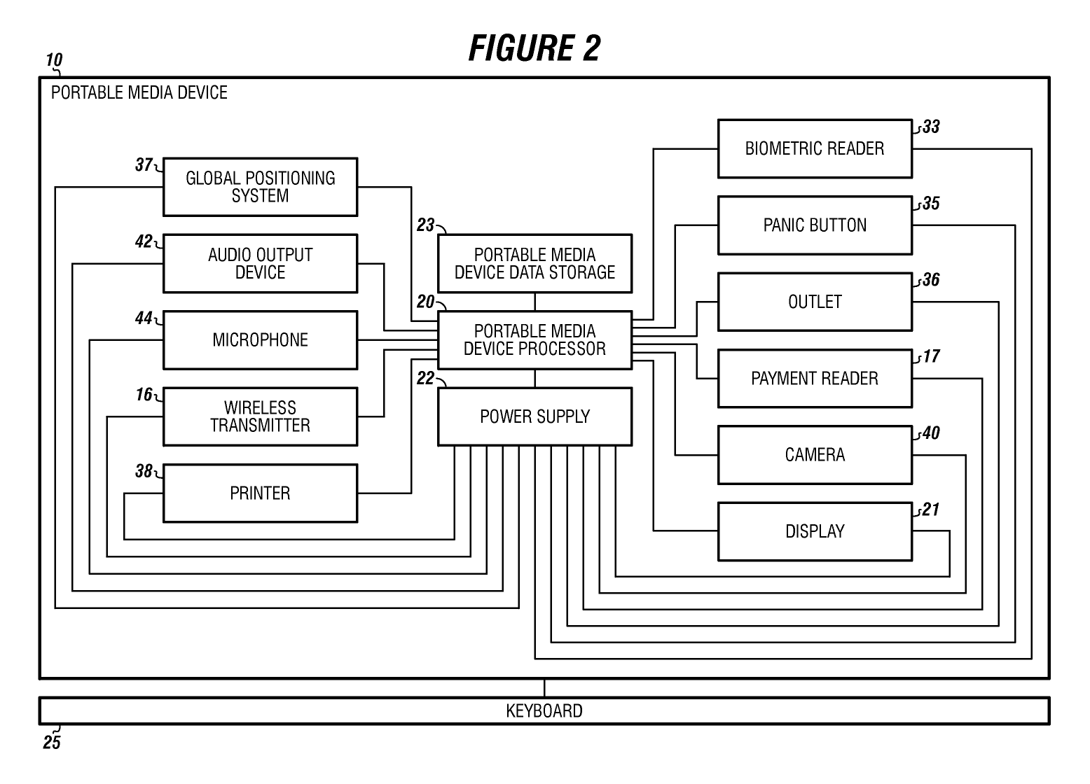

FIG. 2 shows a diagram of the portable media device.

The portable media device 10 can have a display 21 that can communicate with the portable media device processor 20. In embodiments, the display 21 can be an interactive touchscreen or a display with a user input mechanism, such as a keyboard 25.

The portable media device 10 can include a portable media device data storage 23 which can be connected to the portable media device processor 20.

The portable media device 10 can have a wireless transmitter 16 that can remotely communicate with the network and the financial institution.

The portable media device 10 can include a payment reader 17 which can be connected to the wireless transmitter 16 and the portable media device processor 20.

In embodiments the payment reader can be a near field communication reader, a smart chip communication reader, a magnetic strip communication reader, or combinations thereof.

In embodiments, the portable media device 10 can have an outlet 36 for connection to a passenger device, such as the client device, that can enable a direct download of information or digital content from the portable media device to the client device or for charging with electricity.

In embodiments the outlet 36 can provide power and communication. In embodiments the outlet can be used only for power or only for communication.

In embodiments the outlet 36 can be a universal serial bus, a mini-universal serial bus, a micro-universal serial bus, an RS232 outlet, an IPHONE™ connector outlet, an IPAD™ connector outlet, a thunderbolt outlet, or combinations thereof. While this encompasses current and commonly used technology, future products can utilize different connectors and outlets, which can easily be incorporated into the design.

In embodiments the portable media device 10 can have a camera 40 in communication with the portable media device processor 20 and additionally connected to a power supply 22 for recording at least one passenger in the transport vehicle.

In embodiments the portable media device 10 can have an audio output device 42, which in embodiments, can be a speaker such as Advance Acoustic Technology model AK-3208BB-2.

In embodiments the portable media device 10 can have a microphone 44 in communication with the portable media device processor 20 and connected to the power supply 22 which can allow a passenger to provide voice input using the portable media device, such as leaving a verbal message, or providing a biometric reading of a passenger's voice to access the system.

In embodiments the portable media device 10 can have a global positioning system 37 connected to the portable media device processor 20. The global positioning system can be used by the passenger or by a transport vehicle company to follow the driving patterns of the transport vehicle.

In embodiments the portable media device 10 can have a printer 38 in communication with the portable media device processor 20 and connected to the power supply 22. The printer 38 can be a thermal printer.

The display 21 can be an interactive touchscreen display such as those made by Adlink, Inc. The display 21 can be a Smart Panel with an integrated screen and processor.

The portable media device 10 can have a panic button 35. The panic button can be connected to the portable media device processor 20 and the power supply 22. The panic button 35 can be a retractable push button.

The portable media device 10 can include a biometric reader 33. The biometric reader can be an interactive device that is capable of reading the biometric information for later verification and matching with a local or administrative data storage, such as a fingerprint reader made by Zhejiang SFG Technology Co. model number R305F.

The biometric reader can read fingerprints, voice data, facial features, retinal information, or other biometrics used for identification purposes.

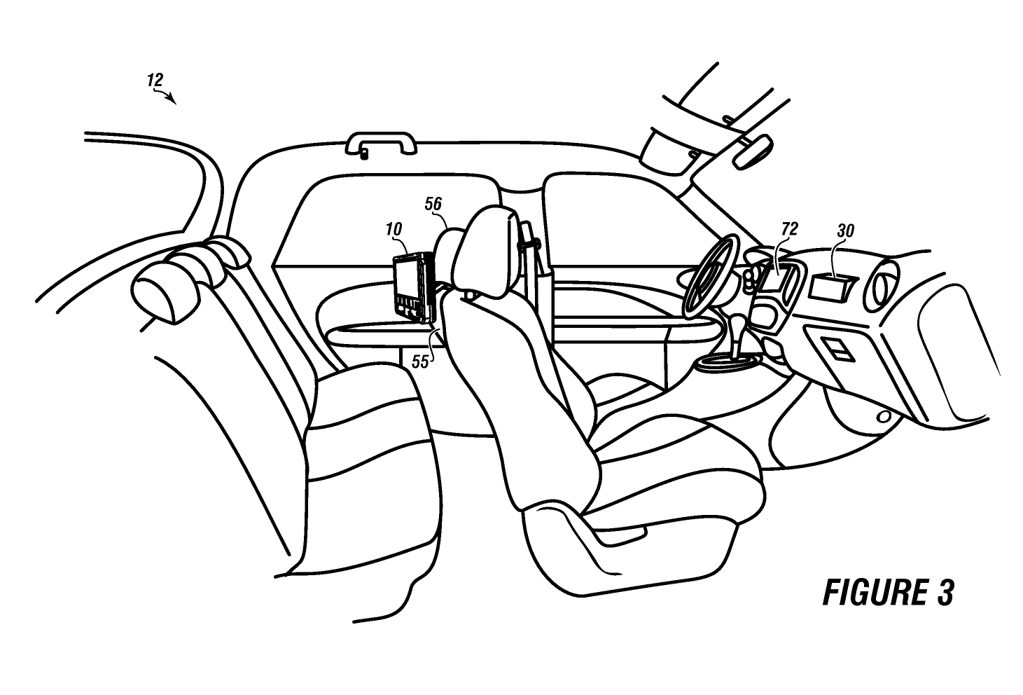

FIG. 3 depicts the portable media device 10 installed in a transport vehicle 12 adjacent the headrest 56 of the driver's seat 55 between the driver's seat and the passenger seat.

The transport vehicle 12 is shown with an onboard trip-tracking computer 30. The onboard trip-tracking computer 30 can communicate with the portable media device 10 via the network.

The onboard trip-tracking computer 30 can track transport vehicle information including vehicle fares, vehicle trip mileage, and vehicle trip duration associated with the transport vehicle using computer instructions in the onboard trip-tracking computer.

The transport vehicle 12 is shown with a driver media device 72 which can be in a wired connection or wireless connection to the onboard trip-tracking computer 30.

In embodiments, the portable media device 10 can provide viewing content to a driver media device 72.

In embodiments, the transport vehicle 12 can be a taxi, a bus, a truck, a van, a limousine, a shuttle boat, a water taxi, a boat, or a similar transport vehicle.

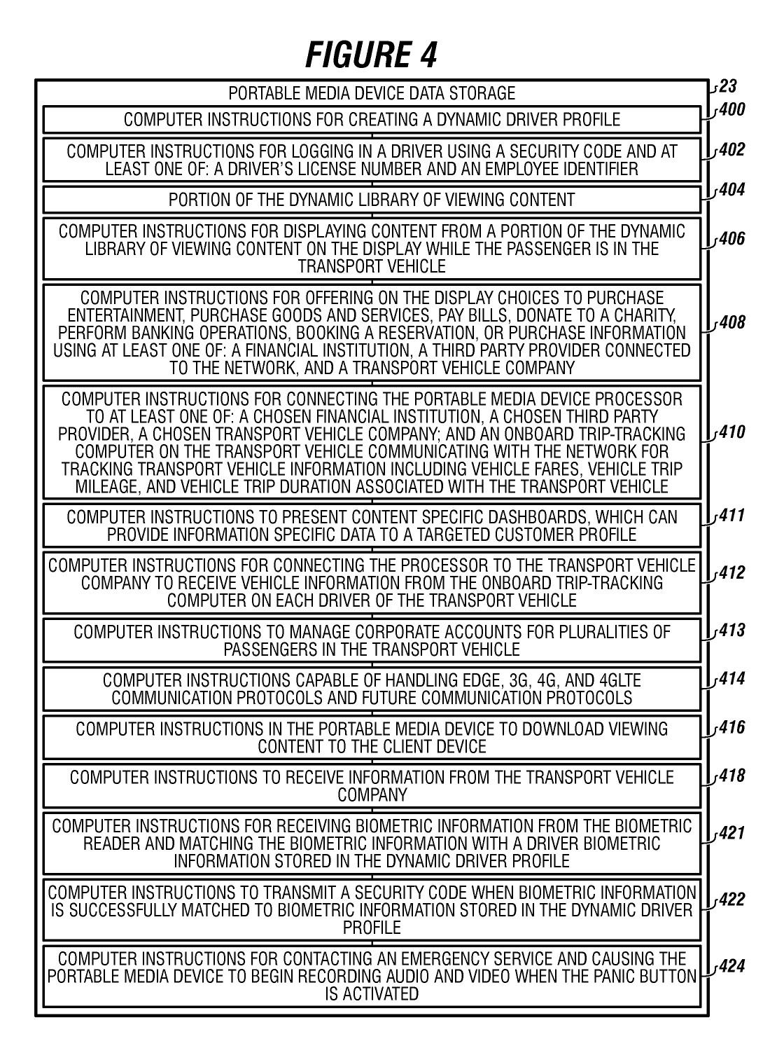

FIG. 4 depicts the portable media device data storage 23.

The portable media device data storage 23 can include computer instructions 400 for creating a dynamic driver profile.

The portable media device data storage 23 can include computer instructions 402 for logging in a driver using a security code and at least one of: a driver's license number and an employee identifier.

The portable media device data storage 23 can include a portion of the dynamic library of viewing content 404.

The portable media device data storage 23 can include computer instructions 406 for displaying content from a portion of the dynamic library of viewing content on the display while the passenger is in the transport vehicle.

The dynamic library of viewing content can include a passenger selected content, a driver selected content, a preselected content, such as preselected by an advertising agency, a transport vehicle company selected content, or combinations thereof.

The portable media device data storage 23 can include computer instructions 408 for offering on the display choices to purchase entertainment, purchase goods and services, pay bills, donate to a charity, perform banking operations, booking a reservation, or purchase information using at least one of: a financial institution, a third party provider connected to the network, and a transport vehicle company.

The portable media device data storage 23 can include computer instructions 410 for connecting the portable media device processor to at least one of: a chosen financial institution, a chosen third party provider, a chosen transport vehicle company; and an onboard trip-tracking computer on the transport vehicle communicating with the network for tracking transport vehicle information including vehicle fares, vehicle trip mileage, and vehicle trip duration associated with the transport vehicle.

The portable media device data storage 23 can include computer instructions 411 to present content specific dashboards, which can provide information specific data to a targeted customer profile.

The portable media device data storage 23 can include computer instructions 412 for connecting the processor to the transport vehicle company to receive vehicle information from the onboard trip-tracking computer on each driver of the transport vehicle.

The portable media device data storage 23 can include computer instructions 413 to manage corporate accounts for pluralities of passengers in the transport vehicle.

The portable media device data storage 23 can include computer instructions 414 capable of handling Edge, 3G, 4G, and 4GLTE communication protocols and future communication protocols.

The portable media device data storage 23 can include computer instructions 416 in the portable media device to download viewing content to the client device.

The portable media device data storage 23 can include computer instructions 418 to receive information from the transport vehicle company.

The portable media device data storage 23 can include computer instructions 421 for receiving biometric information from the biometric reader and matching the biometric information with a driver biometric information stored in the dynamic driver profile.

The biometric data can be voice prints, finger prints, retinal scans, and similar biometric data.

In embodiments, the dynamic driver profile can be stored in the portable media device data storage.

The computer instructions 421 can be used for matching a fingerprint pattern received, a facial pattern received, a voice pattern received, or other commonly used biometric identification patterns to the biometric information stored in the dynamic driver profile.

The portable media device data storage 23 can include computer instructions 422 to transmit a security code when biometric information is successfully matched to biometric information stored in the dynamic driver profile.

The security code can enable the driver to access the system.

The portable media device data storage 23 can also include computer instructions 424 for contacting an emergency service and causing the portable media device to begin recording audio and video when the panic button is activated.

The information from the transport vehicle company can include dispatch information such as trip start time, trip start location, initial flag charge, total time of the trip, length of the trip, and trip end time.

The information from the transport vehicle company can include cashiering information, such as complete driver's profile, including but not limited to name, employee number and accounting status.

The information from the transport vehicle company can include enterprise resource planning information, such as complete driver's profile, including but not limited to name, employee number and accounting status.

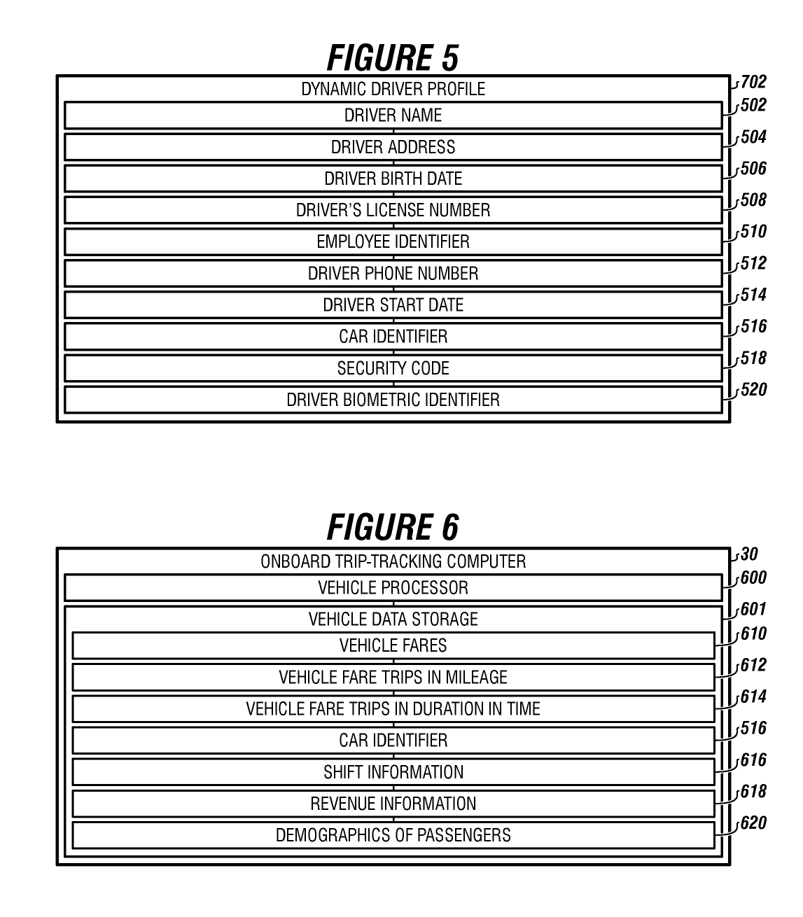

FIG. 5 shows the dynamic driver profile 702.

In embodiments, the dynamic driver profile 702 can be stored in the administrative data storage. The dynamic driver profile 702 can include a security code 518, a driver's license number 508, and an employee identifier 510.

In embodiments, the dynamic driver profile 702 can also include a driver name 502, a driver address 504, a driver birth date 506, a driver phone number 512, a driver start date 514, a car identifier 516, and a driver biometric identifier 520.

FIG. 6 shows an embodiment of the onboard trip-tracking computer 30.

The onboard trip-tracking computer 30 can include a vehicle processor 600 connected to vehicle data storage 601.

The vehicle data storage 601, in embodiments, can include vehicle fares 610, vehicle fare trips in mileage 612, vehicle fare trips in duration in time 614, and/or the car identifier 516.

The vehicle fare trips in duration 614 can include vehicle fare trips in duration performed during a defined window of time.

The vehicle data storage 601, in embodiments, can include shift information 616 including start time of a shift and stop time of a shift.

The vehicle data storage 601, in embodiments, can include revenue information 618 on purchased entertainment, purchased goods and services, paid bills, donations to a charity, performed banking operations, booked reservations, or purchased information.

The vehicle data storage 601, in embodiments, can include demographics of passengers 620. Demographics of passengers can include at least one of: gender, ethnicity, and age.

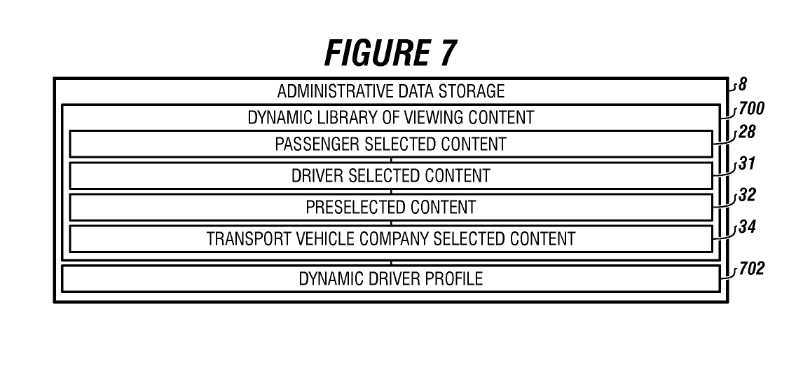

FIG. 7 shows an embodiment of the administrative data storage 8.

The administrative data storage 8 can include the dynamic library of viewing content 700 and at least one dynamic driver profile 702.

The dynamic library of viewing content 700 can include a passenger selected content 28, a driver selected content 31, a preselected content 32, a transport vehicle company selected content 34, or combinations thereof.

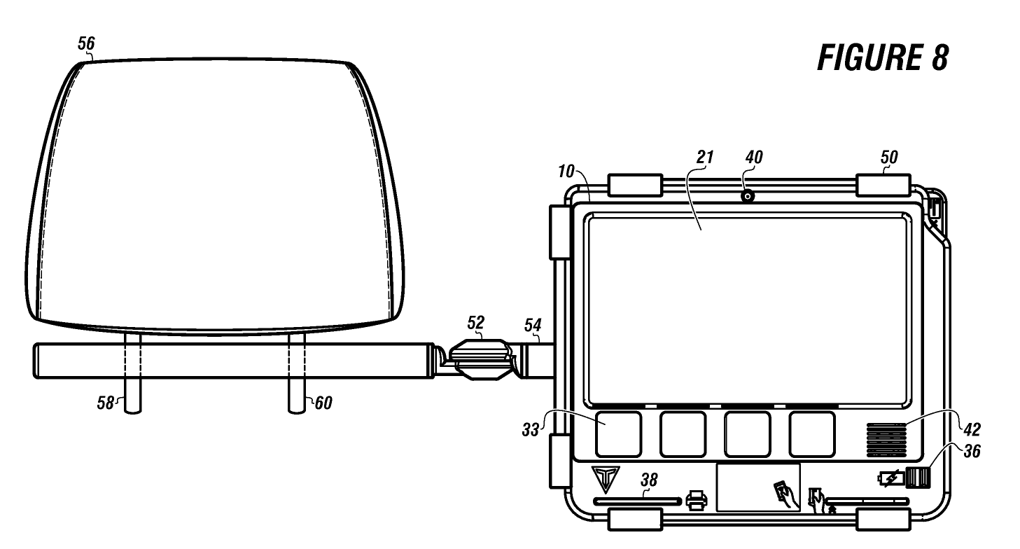

FIG. 8 shows an embodiment of the portable media device 10 in a holding case 50 mounted to the headrest 56 of the transport vehicle.

The holding case 50 can be connected to a joint 52 adapted for collapsing upon an impact by the transport vehicle into another transport vehicle or into a fixed structure.

In embodiments, the holding case 50 can have rounded edges.

In embodiments, the joint 52 can be made of plastic.

The joint 52 can engage a first post 58 and a second post 60 of the headrest 56.

The holding case 50 can have a single quick connect/quick disconnect connector 54.

The portable media device 10 is shown with the display 21, a camera 40, and an audio output device 42, shown here as a speaker.

The outlet 36 is depicted for providing a connection to the client device enabling a direct download of information or digital content from the portable media device 10 to the client device or charging of the client device, such as a cell phone, tablet, laptop or DVD player.

The portable media device 10 is also shown with the printer 38 and the biometric reader 33.

In an embodiment, the system can provide connectivity from a transport vehicle to a transport vehicle company, a financial institution, and a third party provider via a network.

In an embodiment, the network can be in communication with an administrative processor and an administrative data storage. The administrative data storage can have a dynamic library of viewing content.

In this embodiment, a portable media device can be installed in a vehicle, such as a taxi cab, for presenting information from the dynamic library of viewing content to a passenger.

The portable media device can have a portable media device processor and a portable media device data storage.

In embodiments, the administrative data storage can provide a portion or all of the dynamic library of viewing content to the portable media device data storage.

The portable media device can have a display for presenting viewing options or selectable content to a passenger of the vehicle. In embodiments, the display can be an interactive touchscreen display.

In an embodiment, the portable media device can have a Smart Panel comprised of an interactive multi-touch display, computer processor and data storage, such as made by Adlink, Inc., a cellular data communication module, such as Sierra Wireless model Air Prime MC7700 LTE, a GPS module such as Siena Wireless model Air Prime MC7700 LTE, a WiFi communication module such as Intel model Intel Centrino Wireless-N 2230, a magnetic strip reader such as Periferial Dynamics model MMD-1900, a smart chip reader such as Periferial Dynamics model EICM-1000, a near field communication reader such as Periferial Dynamics model NFC-1901, a board capable of integrating the magnetic strip reader, the smart chip reader and the near communication reader into one communication port with the Smart Panel, a camera, a thermal printer such as Cashiotech model TP-486F, a power supply such as Mini Com model M3-ATX-125w, a USB port such as Startec model USBMBADAPT2, a speaker such as Advance Acoustic Technology model AK-3208BB-2, and a multi-pin power and data connector.

In embodiments, the passenger can select content to view from the portion of the dynamic library of viewing content in the portable media device data storage, the driver selects content to view, or content to view is predetermined.

In embodiments, the selectable content can include an information element, an advertisement, a video, a service offering from a vendor, a product offering from a vendor, a purchase option, on-line gaming, a promotional offer, output from a connected onboard computer, or combinations thereof.

In embodiments, the information element can be news, weather, stock market information, trip information, or similar information.

In embodiments, advertisements can be tailored to a location of the transport vehicle, time of day, day of year, demographics of the passenger such as age, race or ethnicity, or can be predetermined content.

In embodiments, a video can be a movie, a commercial, a movie clip, a video broadcast, an infomercial, or similar items.

In embodiments, purchase options can be offered for a product or service. The passenger can choose to select an item for purchase on the portable media device.

In embodiments, purchase options can be tailored to a location of the transport vehicle, time of day, day of year, demographics of the passenger such as age, race or ethnicity, or can be predetermined content.

In embodiments, the passenger can select to shop for or purchase goods and services, pay bills, or view information.

If a passenger selects a purchase, the portable media device in embodiments can have a wireless transmitter for communicating with a network and a financial institution.

The passenger can select multiple items to purchase, and combine the items into a single payment transaction.

In embodiments, the portable media device can accept payment from a credit card, debit card, a charge card, a gift card, or other payment cards using manual input, a magnetic card reader, a near field communication reader, or a smart chip reader.

In embodiments, the system can support two way information exchanges between the portable media device data storage and the administrative data storage. The administrative data storage can wirelessly transmit and receive information from the portable media device data storage.

The administrative data storage can provide all or a portion of the dynamic library of viewing content to the portable media device data storage for selection by a passenger to view, or for display on the portable media device.

In embodiments, the portable media device can have one or more outlets to provide communication, power, or both communication and power.

In embodiments, the portable media data storage can be a removable storage, such as a USB flash memory drive, a memory card, or similar devices capable of storing digital information.

In embodiments, the portable media device can have a WiFi transmitter and receiver for providing a hot spot usable by the passenger to connect to a network, such as a local area network, a wide area network, a satellite network, a global network such as the Internet, or form a peer to peer connection.

The portable media device can be capable of receiving and transmitting information to another computer, such as a taxi meter connected to a transport vehicle company. The portable media device can be used to display, track, and transmit information regarding dispatch, cashiering, or enterprise resource planning.

The portable media device can also include a camera, a speaker, and a microphone enabling a variety of display and recording options. For example, the portable media device can begin recording audio and video upon the panic button being activated. A variety of movies, news, or video clips can be presented to the passenger on the display.

The portable media device can further have a biometric reader to identify a person.

The biometric reader can be used to identify the driver of the transport vehicle, the passenger of the transport vehicle, or combinations thereof.

While these embodiments have been described with emphasis on the embodiments, it should be understood that within the scope of the appended claims, the embodiments might be practiced other than as specifically described herein.

1. A system for providing connectivity from a plurality of transport vehicles to a transport vehicle company, a financial institution, a third party provider, and an administrative processor via a network, the system comprising:
a. the administrative processor and an administrative data storage comprising a non-transitory data storage medium, wherein the administrative processor and the administrative data storage are in a remote location, and wherein the administrative data storage further comprises a dynamic library of viewing content and a dynamic driver profile;
b. a portable media device installed in each of the plurality of transport vehicles for presenting selected viewing content to a passenger, wherein the portable media device presents an interactive dynamic customized dashboard on a display for entertaining, shopping, paying bills, and information gathering by the passenger, each portable media device comprising:
(i) a wireless transmitter for remotely communicating with the network and the financial institution;
(ii) a payment reader connected to the wireless transmitter, wherein the payment reader is at least one of:
1. a near field communication reader;
2. a smart chip communication reader; and
3. a magnetic strip communication reader;
(iii) a portable media device processor communicating with the wireless transmitter;
(iv) a display communicating with the portable media device processor, wherein the display is either an interactive touch screen display or a display and a user input mechanism;
(v) a power supply connected to the portable media device processor and the display; and
(vi) a portable media device data storage connected to the portable media device processor comprising a non-transitory data storage medium, the portable media device data storage further comprising:
1. computer instructions instructing the portable media device processor creating a dynamic driver profile, wherein the dynamic driver profile comprises: a driver's license number, a driver's license expiration date, an employee identifier, and a security code;
2. computer instructions instructing the portable media device processor creating a passenger profile for each passenger using the system;
3. computer instructions instructing the portable media device processor prompting log in by a driver using a security code and at least one of: a driver's license number and an employee identifier;
4. computer instructions instructing the portable media device processor prompting log by a passenger using a security code;
5. computer instructions instructing the portable media device processor retrieving from the administrative data storage and displaying viewing content from a portion of the dynamic library of viewing content on the display while the passenger is in the transport vehicle, wherein the content from the dynamic library of viewing content in the administrative data storage comprises at least one of:
a. a passenger selected content from the administrative processor and the administrative data storage;
b. a driver selected content from the administrative processor and the administrative data storage;
c. a preselected content determined by the administrative processor using the administrative data storage; and
d. a transport vehicle company selected content from the administrative processor and the administrative data storage;
6. computer instructions instructing the portable media device processor offering on the display choices to purchase entertainment, purchase goods, purchase services, pay bills, donate to a charity, perform banking operations, book a reservation, or purchase information using at least one of: the financial institution, the transport vehicle company, and the third party provider, connected to the network;
7. computer instructions instructing the portable media device processor connecting to at least one of: a chosen financial institution, a chosen third party provider, a chosen transport vehicle company; and an onboard trip-tracking computer on the transport vehicle communicating with the network, wherein the onboard trip-tracking computer tracks transport vehicle information including vehicle fares, vehicle trip mileage, and vehicle trip duration;
8. computer instructions instructing the portable media device processor connecting to the transport vehicle company to receive vehicle information on each driver of the transport vehicle from the onboard trip-tracking computer;
9. computer instructions instructing the portable media device processor presenting content specific dashboards on the display which can provide information specific data using the passenger profile;
10. computer instructions instructing the portable media device processor managing corporate accounts for each passenger with a passenger profile in one of the transport vehicles; and
11. computer instructions for selectively instructing the portable media processor managing communication between the payment reader and the financial institutions, wherein the instructions enable the portable media device processor to handle Edge communication protocols, 3G communication protocols, 4G communication protocols, and 4GLTE communication protocols between the payment reader and the financial institutions via the network; and
c. an outlet on the portable media device for connection to a client device, wherein the outlet provides communication, power, or both communication and power.
wherein the system provides connectivity for the passenger in each transport vehicle of the plurality of transport vehicles to purchase entertainment, purchase goods and services, pay bills, donate to a charity, perform banking operations, book a reservation, or purchase information using at least one of: the financial institution, the transport vehicle company, and the third party provider connected to the network.

2. (canceled)

3. The system of claim 2, wherein the outlet provides communication, power, or both, and is selected from the list comprising at least one of:
a. a universal serial bus;
b. a mini-universal serial bus;
c. a micro-universal serial bus;
d. an RS232 outlet;
e. a thunderbolt outlet;
f. an IPHONE™ connector outlet; and
g. an IPAD™ connector outlet.

4. The system of claim 1, wherein the transmitter is a WiFi transmitter and a WiFi receiver.

5. The system of claim 1, further comprising a printer in communication with the portable media device processor and connected to the power supply.

6. The system of claim 1, further comprising a camera in communication with the portable media device processor and connected to the power supply for recording at least one passenger in the transport vehicle.

7. The system of claim 1, further comprising an audio output device and a microphone in communication with the portable media device processor and connected to the power supply.

8. The system of claim 1, wherein the network comprises a cellular network, a global communication network, a satellite network, a local area network, a wide area network or combinations thereof.

9. The system of claim 1, further comprising a holding case comprising a joint for collapsing upon an impact by the transport vehicle into another transport vehicle or into a structure which can attach to a floor of the transport vehicle.

10. The system of claim 9, wherein the holding case has rounded edges, and wherein the joint engages a first post and a second post of a headrest.

11. The system of claim 10, wherein the holding case has a single quick connect/quick disconnect connector.

12. The system of claim 1, wherein the portable media device processor is a computer, a laptop, a tablet, a smart panel with integrated motherboard, or a personal digital assistant.

13. The system of claim 1, wherein each transport vehicle of the plurality of transport vehicles is a taxi, a bus, a truck, a van, a limousine, a shuttle boat, a water taxi, or a boat.

14. The system of claim 1, wherein the portable media device data storage is a portable data storage which is removable and re-connectable to the portable media device processer.

15. The system of claim 1, wherein the viewing content is an information element, an advertisement, a video, a service offering from a vendor, a product offering from a vendor, a purchase option, on-line gaming, a promotional offer, or output from a connected onboard computer.

16. The system of claim 1, wherein computer instructions in the portable media device data storage for connecting the client device to the portable media device to download the viewing content to the client device.

17. The system of claim 1, further comprising computer instructions in the portable media device data storage instructing the portable media device processor to receive from the transport vehicle company:
a. dispatch information;
b. cashiering information; and
c. enterprise resource planning information.

18. The system of claim 1, further comprising computer instructions in the portable media device data storage instructing the portable media device processor to transmit transport vehicle information for each transport vehicle of the plurality of transport vehicles to the transport vehicle company using the network, wherein the transport vehicle information includes:
a. shift information including a start time of a shift and a stop time of a shift;
b. revenue information on purchased entertainment, purchased goods and services, paid bills, donations to the charity, performed banking operations, booked reservations, or purchased information;
c. vehicle fare trips in duration performed during a defined window of time; and
d. demographics of passengers including at least one of: a gender, an ethnicity, and an age.

19. The system of claim 1, further comprising a driver media device connected to the onboard trip-tracking computer and the portable media device providing viewing content to a driver.

20. The system of claim 1, further comprising a panic button, wherein the panic button is configured to contact an emergency service when activated.

21. The system of claim 20, further comprising computer instructions in the portable media device data storage instructing the portable media device processor to automatically begin recording audio and video by the portable media device when the panic button is activated.

22. The system of claim 1, further comprising:
a. a biometric reader connected to the portable media device processor and the portable media device data storage; and
b. computer instructions in the portable media device data storage instructing the portable media device processor to receive biometric information from the biometric reader and matching the biometric information with a driver biometric information stored in the dynamic driver profile, wherein the dynamic driver profile is stored within:
(i) the portable media device data storage;
(ii) the administrative data storage; or
(iii) combinations thereof.
